(19) United States
(12) Patent Application Publication
(10) Pub. No.: US 2007/0276952 A1
(43) Pub. Date: Nov. 29, 2007

(54) Data packet decoding

(76) Inventor: Kevin Mitchell, Edinburgh (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/805,224

(22) Filed: May 22, 2007

(30) Foreign Application Priority Data
May 23, 2006 (GB) 0610212.3

(51) Int. Cl. G06F 15/16

(52) U.S. Cl. 709/230

(57) ABSTRACT

Apparatus and method for generating decoding instructions for a decoder (262) for decoding data packets from a telecommunications network, each of the data packets having a plurality of fields formatted in a predetermined protocol defined by a protocol specification. The apparatus comprises an input (251), an instruction generator (215) and an output (221), the instruction generator (215) including an analyzer for analyzing the protocol specification (250) to infer disposition constraints for each field formatted in the corresponding protocol, a module for determining an appropriate representation of that particular field based on the inferred disposition constraints so as to optimize operation of the decoder (264), and a generator for generating instructions for controlling the decoder (264) to decode the data packets from the telecommunications network and to store decoded information from a particular field according to the appropriate representation to optimize reuse of that decoded information.

This invention relates to decoding data packets in a telecommunications network, specifically, though not exclusively, for generating decoding instructions to be used for the decoding of data packets from a telecommunications network.

### BACKGROUND

Many telecommunication management applications need to decode data packets efficiently. For example, many modern switched telecommunications systems (in particular, modern Public Switched Telephone Networks (PSTNs) and Public Land Mobile Networks (PLMNs)) are formed by two related but separate network infrastructures: a bearer or transmission network for carrying end-user voice and data traffic, and a signalling network for controlling the setup and release of bearer channels through the bearer network in accordance with control signals transferred through the signalling network (sometimes known as out-of-band signalling). Such signalling traffic needs to be monitored for billing and fraud detection purposes. In some cases, a system monitoring for “denial of service” attacks may need to perform a packet inspection to detect the signature of an attack. In other cases, an Operation Support System (OSS) monitoring Service Level Agreements (SLAs) needs to distinguish between different packet flows. A network analyzer probing for erroneous behavior may need to examine, in detail, selected packets. An OSPF (Open-Shortest-Path-First) based topology discovery component may need to examine specific routing information within packets.

The packets flowing through the network may be formatted according to a number of different protocols. Each packet is formed of a sequence of bits, the sequence being divided into fields. In some protocols, the fields may be further divided in a hierarchical fashion into sub-fields. In this regard, although the term “field” will be used hereinafter, it will be appreciated that it is intended to include “subfields” within this term. In order to monitor the packets, the packets must be decoded, at least to ascertain their hierarchical structure, with the decoding being dependent on the particular protocol in which the packet has been formatted. Each protocol is defined by a protocol specification, which is, of course, known. Thus, in order to decode packets on the network, a decoder is provided that decodes packets formatted in one or more particular protocols of interest, the decoding operation being specified based on the protocol specifications of the protocols of interest. Of course, if all the possible protocol specifications are known, a single (very complicated) decoder may be provided to decode all the packets. Usually, however, decoders are provided just for particular protocols of interest. In order to implement the decoder, the operations necessary for the decoding are derived from the protocol specification. These operations can be compiled manually, or by using a specialized protocol compiler for those cases where the protocol is specified formally. It will be apparent that if tens, or even hundreds, of different protocol specifications have to be supported, it can be quite complicated to produce the decoder.

In order to decode a field, the decoder must know its location and size, in particular, its start bit offset and either its end bit offset. The term “disposition” will be used hereinafter to include both the alignment and the size of a field, so that the decoder can determine exactly where each field begins and ends within a packet. In this regard, the disposition of a field is defined by disposition parameters which may be predefined, or by disposition constraints that may include parameters (if known) but also include information (that may be partial) regarding some aspect of the disposition of a field, thereby constraining the parameters, even though the parameter is not completely defined. For example, instead of a defined starting point, the disposition constraint may include information that the starting point is at an offset that is dependent on the value of some other field, and a size of the field may not be known except that it will be, for example, an even number of bits long. In order to be able to decode a field whose disposition is constrained by a parameter that is dependent on a result from a previous field, that result must be stored so that the result can be used to decode the field. Therefore, the decoder must know that it needs to store the result of decoding the earlier field and it needs to know, when decoding the later field, where to look to find the result of the decoding of the earlier field. Accordingly, the instructions generated for the decoder based on the protocol specification, should provide the decoder with instructions to store the result of decoding of a particular field and to access that result when needed to decode another field. However, if all results are to be stored for later use, this can take a lot of memory and be inefficient.

Furthermore, in some cases, after the decoder has decoded the packets, the decoded data from the packets is provided to an application processor to carry out data processing on the data. This post-processing approach, where operations are executed after the entire packet has been decoded, is also often inefficient. An application processor might only require access to a small number of fields within the packet, and the work required to decode the other fields can be viewed as wasted effort. Thus, in some cases, some of the user application processing instructions can be interleaved with the decoding instructions. In these circumstances, the user application processing instructions are interleaved with the protocol specification to form an augmented protocol specification. The user application processing instructions will often include metavariables that are used to refer to some particular field in the data packet. The decoder itself, of course, needs to know the particular value of the particular field at this point in order to carry out the application processing, so the instructions to the decoder must replace the metavariable in the augmented protocol specification with some code that enables the decoder to access that particular field value. Thus, each metavariable is associated with a particular field, for example, by matching them in a table. Each field is associated with appropriate disposition constraints of the field, again, for example, in a table matching the fields to the disposition parameters. However, this treats each field uniformly, which is inefficient, since some fields may have known constant parameters so that storing the full disposition constraints for all such fields using tables would be cumbersome.

The present invention therefore seeks to provide an apparatus for generating decoding instructions for a decoder for decoding data packets from a telecommunications network, which overcomes, or at least reduces the problems of the prior art.

### SUMMARY OF THE DISCLOSED EMBODIMENTS

According to one aspect of this invention there is provided an apparatus for generating decoding instructions for a decoder for decoding data packets from a telecommunications network, each of the data packets having a plurality of fields formatted in a predetermined protocol defined by a protocol specification, the apparatus comprising an input, an instruction generator and an output, the apparatus receiving the protocol specification at the input thereof and wherein the instruction generator includes an analyzer for analyzing the protocol specification to infer disposition constraints for each field formatted in the corresponding protocol, a module for determining an appropriate representation of that particular field based on the inferred disposition constraints so as to optimize operation of the decoder, and a generator for generating instructions for controlling the decoder to decode the data packets from the telecommunications network and to store decoded information from a particular field according to the appropriate representation to optimize reuse of that decoded information.

According to one embodiment, the module determines an appropriate representation of the particular field based on the inferred disposition constraints and/or on other references to that field in the protocol specification.

The instruction generator may comprise a memory for storing the representations determined for particular fields. The protocol specification may be an augmented protocol specification including user application instructions attached thereto and the generator may further generate instructions for controlling the decoder to execute the user application instructions. The generator may further generate instructions for controlling the decoder to retrieve the stored decoded information from a particular field when the protocol specification includes a reference to that particular field.

The disposition constraints may comprise absolute and/or relative constraints including one or more of the following: a starting bit of the field in the data packet, a finishing bit of the field in the data packet, an offset from a known position in the data packet, a length of the field, a known type of field.

According to a second aspect, the invention provides a decoding system for decoding data packets from a telecommunications network, each of the data packets having a plurality of fields formatted in a predetermined protocol defined by a protocol specification, the decoding system comprising a decoder and an apparatus described above, the decoder comprising a first input for receiving the decoding instructions, directly or indirectly, from the apparatus, a second input for receiving data packets from the telecommunications network, a decoding module including a memory and an output, the decoding module decoding the data packets from the second input according to the decoding instructions received at the first input, storing appropriate decoded information from a particular field according to the decoding instructions in the memory and providing data from the decoded data packets at the output.

The decoding system may further comprise a compiler having an input coupled to the output of the apparatus and an output coupled to the input of the decoder for compiling the decoding instructions from the apparatus into a format suitable for the decoder.

According to a third aspect, the invention provides a method of generating decoding instructions for a decoder for decoding data packets from a telecommunications network, each of the data packets having a plurality of fields formatted in a predetermined protocol defined by a protocol specification, the method comprising receiving the protocol specification, analyzing the protocol specification to infer disposition constraints for each field formatted in the corresponding protocol, determining an appropriate representation of that particular field based on the inferred disposition constraints so as to optimize operation of the decoder, and generating instructions for controlling the decoder to decode the data packets from the telecommunications network and to store decoded information from a particular field according to the appropriate representation to optimize reuse of that decoded information.

In one embodiment, determining an appropriate representation of the particular field is further based on other references to that field in the protocol specification.

The method may further comprise storing the representations determined for particular fields.

The protocol specification may be an augmented protocol specification including user application instructions attached thereto and the method further comprises generating instructions for controlling the decoder to execute the user application instructions.

The method may further comprise generating instructions for controlling the decoder to retrieve the stored decoded information from a particular field when the protocol specification includes a reference to that particular field.

The disposition constraints may comprise absolute and/or relative constraints including one or more of the following: a starting bit of the field in the data packet, a finishing bit of the field in the data packet, an offset from a known position in the data packet, a length of the field, a known type of field.

According to a fourth aspect, the invention provides a method of decoding data packets from a telecommunications network, each of the data packets having a plurality of fields formatted in a predetermined protocol defined by a protocol specification, comprising receiving, directly or indirectly, the decoding instructions generated by the method described above, receiving data packets from the telecommunications network, decoding the data packets according to the received decoding instructions, storing appropriate decoded information from a particular field according to the decoding instructions, and providing data from the decoded data packets.

The method may further comprise compiling the decoding instructions generated by the method described above into a format suitable for use by a decoder.

### BRIEF DESCRIPTION OF DRAWINGS

A method and apparatus in accordance with one embodiment of this invention, for generating decoding instructions to be used for the decoding of data packets from a telecommunications network, will now be described, by way of example, with reference to the accompanying drawings, in which:

FIG. 1 is a diagram showing an example of the structure of a data packet;

FIG. 2 is a diagram showing an example of an augmented protocol specification corresponding to the data packet structure of FIG. 1;

FIG. 3 is a schematic diagram of an apparatus according to one embodiment of the present invention; and

FIG. 4 is a schematic flow diagram of the operation of the instruction generating apparatus of FIG. 3.

### DETAILED DESCRIPTION

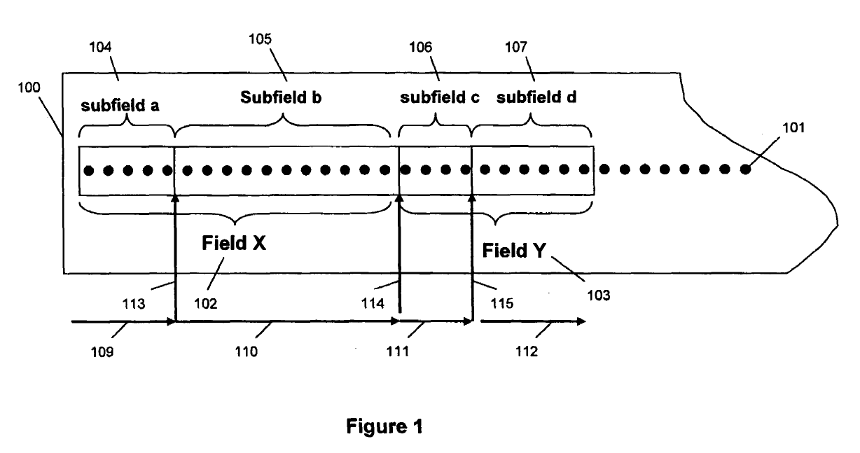

Thus, FIG. 1 is a diagram showing an example packet structure as known in the art. There is shown a packet 100, formed of a bit sequence 101, divided into several fields, e.g. Field X 102, and Field Y 103, where one or more of the fields may be subdivided into subfields. In this case, Field X 102 is shown as subdivided into subfield a 104 and subfield b 105, and Field Y 103 is shown as subdivided into subfield c 106 and subfield d 107. Field lengths 109, 110, 111, 112 as well as bit offsets 113, 114, and 115 are also shown.

In general, a field 102 or 103 or a subfield 104 to 107, might start on an arbitrary bit alignment boundary, and have a length consisting of an arbitrary, and variable, number of bits. Therefore, in general, a field 102, 103 has to be represented by a starting address, a bit offset into the byte starting at this address, and the total number of bits. Although some or all of this information may be predetermined and defined in the protocol specification, in some cases, some of the information, such as the bit offset and the field (or subfield) length, may be provided as information encoded within a previous field or subfield, again as may be defined in the protocol specification.

As mentioned above, the purpose of decoding the data packets is to enable data processing applications to process the data from the data packets to analyse the operation of the telecommunication network to help optimize various aspects of its management. In some cases, the particular data that is actually required from the data packets may be a relatively small part of the overall data packet, so that decoding the entire data packet prior to carrying out the data processing would be rather inefficient. Accordingly, the protocol specification can be augmented by the addition of one or more operations which are taken from the data processing application that would, conventionally, have been provided after the decoding operation. These operations contain metavariables that refer to fields, which would need to be previously decoded in order to allow the operation to proceed.

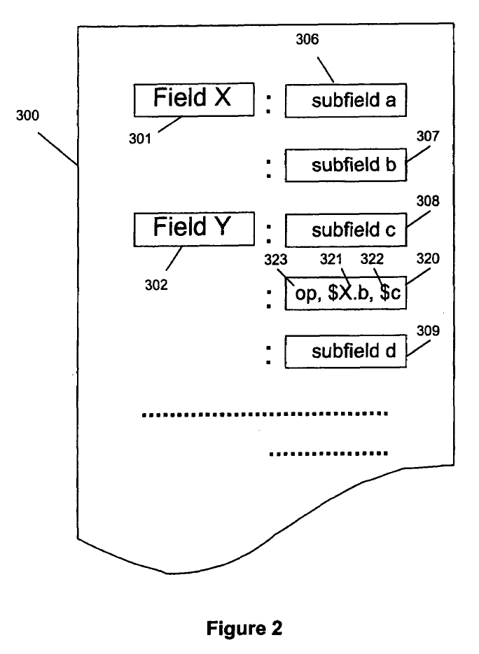

As shown in FIG. 2, an augmented protocol specification 300 includes definitions of the field structure, showing the fields Field X 301, and Field Y 302 in the left hand column and the structure of these fields in the right hand column. In this case, for the example of the data packet shown in FIG. 1, Field X 301 is defined by subfield a 306 and subfield b 307, whereas Field Y 302 is defined by subfield c 308 and subfield d 309. These are defined in the protocol specification. In the augmented protocol specification 300 an operation 320 is also defined. In this case, the operation 320 is shown between subfield c 308 and subfield d 309 and includes a particular operational command 323, which needs to be carried out on metavariables $X.b 321 and $c 322. In this case, the metavariable $X.b 321 refers to subfield b 307 within field X 301 and metavariable $c refers to subfield c 308. Since the operation 320 is embedded between subfields c and d, it can refer directly to subfield c, but can only refer to subfield b as part of the hierarchy of field X. Thus, as soon as field X 301 and subfield c 308 have been decoded, the operation 320 can be carried out. Although, of course, the operation 320 could be carried out later, there is no need to do so since it only requires field X 301 and subfield c 308.

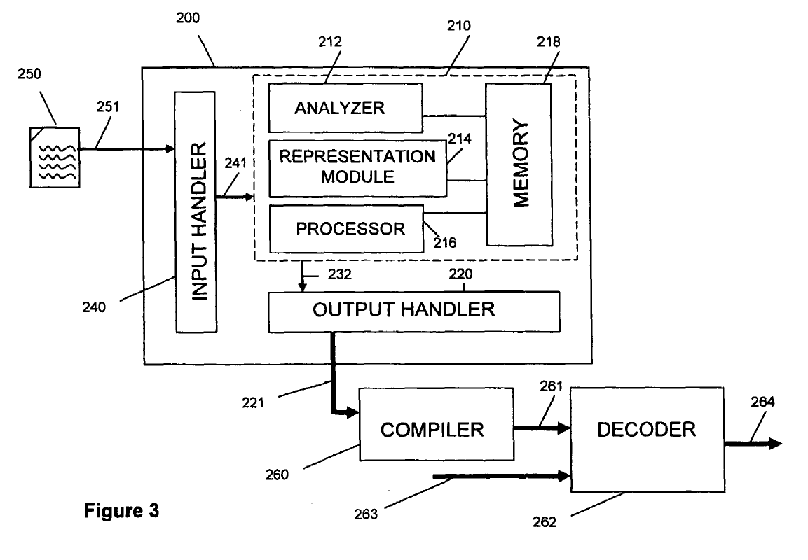

FIG. 3 shows one embodiment of an apparatus for generating decoding instructions to be used for the decoding of data packets from a telecommunications network. An augmented protocol specification 250 is provided, for example as a text file, at an input 251 to an instruction generating apparatus 200. The instruction generating apparatus 200 includes an input handler 240, an instruction generator 210 and an output handler 220. The instruction generator 210 is formed by an analyzer 212, a representation determining module 214, a memory 218 and an instruction processor 216. The augmented protocol specification 250 is passed from the input 251 to the input handler 240, where it is appropriately handled, before being passed on a link 241 to the memory 218 in the instruction generator 210. The memory 218 is accessed by the analyzer 212, by the representation determining module 214 and the instruction processor 216 and is used to store decoder instructions. These decoder instructions are then passed, via the output handler 220, where they may be appropriately handled, to a decoder 262. If necessary, the decoder instructions are passed via output 221 to a compiler 260, which translates the decoder instructions to a machine readable form for the decoder and then passes them from its output 261 to the decoder 262. Of course, if the instructions are generated in a form readable by the decoder, then the compiler is not necessary.

As mentioned above, in order to decode a packet, the decoder must know the disposition constraints (alignment and size parameters) for each field in a packet. These disposition constraints might be very specific, e.g. a field always starts at bit offset X from the start of the packet/PDU, and is always Y bits in length. At the other extreme the constraints might be vacuous, e.g. a field starts at an unknown bit offset, and is an unknown number of bits long. Clearly at run-time, for a specific packet, the starting offset and length will be known. Otherwise, the packet could not be decoded. However, at the time of generating the decoder instructions the field may still have an unknown offset or size. The constraints may also provide partial information, such as that a field will start on a long-word boundary, and consist of an even number of bytes, etc.

Therefore, the analyzer infers disposition constraints on fields from the protocol specification, where these constraints may include partial information (e.g. “do not know how big the field will be, but it will contain an even number of bytes”). There will, of course, be multiple ways of representing decoded field values, where the choice depends on the constraints deduced for each field. The representation determining module 214 therefore determines an appropriate representation for the field information, based on the inferred disposition constraints. The choice of appropriate representation is then stored in the memory 218 and the instruction processor 216 generates the code for the decoder. The generated code includes code generated to store the decoded information about the field at run-time, together with matching code that replaces any references to the field by code that, at run-time, retrieves the decoded value.

The instructions might be code in a high-level language such as C. The execution of these instructions, at run-time, will result in the system attempting to match the protocol structure against an input packet. Fields may depend on previously decoded fields. For example, a field B may consist of N instances of a type, where N is determined by the value of some previously decoded field A. So it may be necessary to store information about each decoded field to allow properties of this field to be used later in the decoding process.

If nothing useful about the alignment or size of a field could be inferred from the protocol specification relating to that field, then the decoder could, on matching this field at run-time, record the byte offset of the start of the field, the bit offset of the start within this byte, and the field length, in bits. So, in the simplest approach, the decoder could store all this information about each field it decodes in a large data store. Later references would then be replaced by code that accessed this store, e.g. using a numeric key, and then used the retrieved values to perform the required operation. However, this will often be inefficient because, for example, in the simple case of a field that is a fixed size, e.g. 32 bits, and where all references to this field just want to treat the field as an integer, every reference would be translated into code that looked up the byte offset, bit offset, and length, in the data store, then retrieved the bit sequence represented by these parameters, and finally converted this bit sequence into an integer, e.g. in a register. But in this example it would be preferable for the decoder, having decoded the field, to store the field as an integer in memory, or perhaps even in a register if the value was to be used almost immediately, or frequently. Similarly, if the field always started on a byte boundary then there would be no need to store the bit offset, making it both quicker to store the field details, and reconstruct/use the field value later.

Therefore, when the decode instructions are being generated, for each field, the inferred constraints are augmented with information about how these fields are to be used later, in order to decide on the appropriate representation to use for the particular field. For example, later references to the field in the protocol specification may only require partial information from the field and this would therefore allow a representation to be chosen that is more efficient for the use to which the decoded information is to be put. The representation determining module 214 therefore determines an appropriate representation for the field information, based on the inferred disposition constraints and on further references to the particular field in the protocol specification. This is particularly useful when an augmented protocol specification is used, since the user applications may make only particularly limited demands on the field information that is decoded.

Each representation explicitly stores some information about the field, and other bits of information may be implicit. So, for example, one representation might explicitly store a length field, whereas in another this may be implicit in the representation (e.g. one representation might just store 16 bit quantities, and so only be used when it can be inferred that the field will always be 16 bits in length, and so there is no need to also store the field length as an explicit parameter).

The instruction generator 210 may also be used to analyse the augmented protocol specification and determine which fields (or subfields) are required for an operation to be able to be executed. If a particular field is not required for an operation that is included in the augmented protocol specification, then there is no need for that field to be decoded. Thus, the instruction generator 210 looks at all the operations that are included within the augmented protocol specification 250 and determines which fields and subfields are directly required for those operations and which fields and subfields are required in order to decode the directly required fields and subfields. The instruction generator 210 then generates appropriate decoding instructions for the decoder so that the decoder only decodes those fields and subfields that are necessary to support the operations within the augmented protocol specification. It will be appreciated that, depending on the protocol specification, if a particular subfield is required, it may be possible to decode only that subfield within a field, or it may be necessary to decode the entire field containing that subfield or it may be possible to decode all of the field preceding that required subfield, but not the rest of the field following the required subfield.

Thus, if every field and subfield had a fixed offset, without those offsets being determined from earlier fields or subfields, then the decoding of any field or subfield that was not required by an operation could be skipped. Unfortunately most protocols are more complex than this, using variable length fields, optional fields, and choices (choice determinants). Such features may force the decoder to have to decode additional fields. As operations often need to refer to the values of previously decoded fields, the operations introduce implicit dependencies on other fields. By analyzing such dependencies, the number of fields that have to be decoded to find expressions for bit offsets and lengths, for example, can be minimized, thereby minimizing the overheads of the processing. The decoding instructions generated by the instruction generator 210 thus include decoding commands and operations to be executed on data from decoded fields

The output handler 220 may also be connected to display the decoding instructions and/or the augmented protocol specification on a Graphical User Interface (GUI) (not shown). The instruction generator 200 can be implemented on a Unix machine, but it will be obvious to someone skilled in the art that it could be implemented in any other suitable manner.

Generally, of course, the instruction generator 200 operates offline and provides the decoding instructions to the decoder 262, which, once programmed with the decoding instructions, receives online the data packets to be decoded at an input 263 and provides an analysis of the decoded packets at an output 264. The protocol decoder can thus be specifically controlled for the particular operations that are required to be carried out.

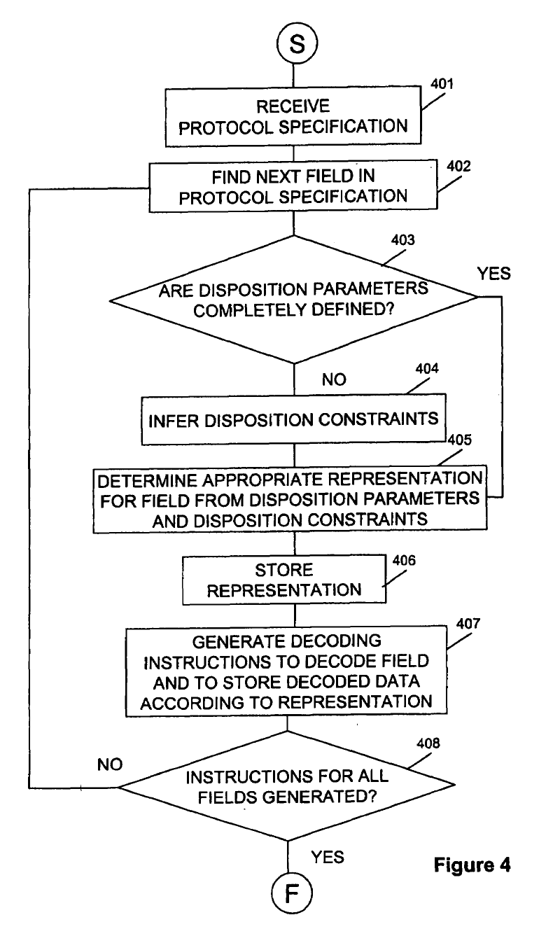

FIG. 4 shows, schematically, the operation of the instruction generator 200. In this figure, the operation starts at “S” and finishes at “F”. The process begins by receiving a protocol specification, as indicated at box 401. A first field in the protocol specification is first found (box 402) and the field is analyzed to determine whether the disposition parameters are completely defined or whether the disposition parameters are dependent on a result from some other field. If they are completely defined, then the process moves on to box 405. If not, the process moves on to box 404, where the disposition constraints are inferred from the protocol specification. The disposition constraints may include as much or as little information as can be inferred from the protocol specification regarding any limitations that are known about the disposition parameters. Once the disposition constraints have been determined, the process moves to box 405, where a suitable representation of the field is determined from a knowledge of the disposition parameters and disposition constraints and from the protocol specification. For example, by knowing that the results of the decoding of the field are to be used in a particular format or in a particular way later in the decoding process, a representation of the results that are most suitable for that later use can be determined. If, for example, it is known that only the size of a previous field was later required, then there would be no need to use a representation that recorded the exact bit sequence.

The appropriate chosen representation is then stored in a memory, as indicated in box 406. Once the representation has been stored, decoding instructions are generated (as shown in box 407) for the decoder to be able to decode the data packets from the network. The decoding instructions also include instructions for storing the results of the decoding for a particular field in the chosen representation and provide instructions whereby that stored result can then be accessed when it is needed in order to decode later fields. Finally, in box 408, it is determined if instructions have been generated for deciding all fields in the protocol specification. If not, the process returns to box 401 to take the next field and analyse it. Clearly, if the protocol specification is augmented with user application instructions, then these are also used to generate appropriate instructions for the decoder to be able to execute the user application instructions. Such user application instructions in the protocol specification may also provide information whereby an appropriate representation may be determined according to the later needs of the user application instructions.

It will be appreciated that although only one particular embodiment of the invention have been described in detail, various modifications and improvements can be made by a person skilled in the art without departing from the scope of the present invention. For example, it will be apparent that, although the embodiment of the invention described above makes use of an augmented protocol specification, it will work with protocol specifications that are not augmented, since its operation is not dependent on the fact that user application instructions are present in the protocol specification.

1. Apparatus for generating decoding instructions for a decoder for decoding data packets from a telecommunications network, each of the data packets having a plurality of fields formatted in a predetermined protocol defined by a protocol specification, the apparatus comprising an input, an instruction generator and an output, the apparatus receiving the protocol specification at the input thereof and wherein the instruction generator includes:
an analyzer for analyzing the protocol specification to infer disposition constraints for each field formatted in the corresponding protocol,
a module for determining an appropriate representation of that particular field based on the inferred disposition constraints so as to optimize operation of the decoder, and
a generator for generating instructions for controlling the decoder to decode the data packets from the telecommunications network and to store decoded information from a particular field according to the appropriate representation to optimize reuse of that decoded information.

2. Apparatus according to claim 1, wherein the module determines an appropriate representation of the particular field based on the inferred disposition constraints.

3. Apparatus according to claim 1, wherein the module determines an appropriate representation of the particular field based on other references to that field in the protocol specification

4. Apparatus according to claim 1, wherein the instruction generator comprises a memory for storing the representations determined for particular fields.

5. Apparatus according to claim 1, wherein the protocol specification is an augmented protocol specification including user application instructions attached thereto and the generator further generates instructions for controlling the decoder to execute the user application instructions.

6. Apparatus according to claim 1, wherein the generator further generates instructions for controlling the decoder to retrieve the stored decoded information from a particular field when the protocol specification includes a reference to that particular field.

7. Apparatus according to claim 1, wherein the disposition constraints comprise absolute and/or relative constraints including one or more of the following:
a starting bit of the field in the data packet;
a finishing bit of the field in the data packet;
an offset from a known position in the data packet;
a length of the field;
a known type of field.

8. A decoding system for decoding data packets from a telecommunications network, each of the data packets having a plurality of fields formatted in a predetermined protocol defined by a protocol specification, the decoding system comprising a decoder and an apparatus according to any preceding claim, the decoder comprising a first input for receiving the decoding instructions, directly or indirectly, from the apparatus, a second input for receiving data packets from the telecommunications network, a decoding module including a memory and an output, the decoding module decoding the data packets from the second input according to the decoding instructions received at the first input, storing appropriate decoded information from a particular field according to the decoding instructions in the memory and providing data from the decoded data packets at the output.

9. A decoding system according to claim 8, further comprising a compiler having an input coupled to the output of the apparatus and an output coupled to the input of the decoder for compiling the decoding instructions from the apparatus into a format suitable for the decoder.

10. A method of generating decoding instructions for a decoder for decoding data packets from a telecommunications network, each of the data packets having a plurality of fields formatted in a predetermined protocol defined by a protocol specification, the method comprising:
receiving the protocol specification;
analyzing the protocol specification to infer disposition constraints for each field formatted in the corresponding protocol;
determining an appropriate representation of that particular field based on the inferred disposition constraints so as to optimize operation of the decoder; and
generating instructions for controlling the decoder to decode the data packets from the telecommunications network and to store decoded information from a particular field according to the appropriate representation to optimize reuse of that decoded information.

11. A method according to claim 10, wherein determining an appropriate representation of the particular field is further based on other references to that field in the protocol specification.

12. A method according to claim 10, further comprising storing the representations determined for particular fields.

13. A method according to claim 10, wherein the protocol specification is an augmented protocol specification including user application instructions and the method further comprises generating instructions for controlling the decoder to execute the user application instructions.

14. A method according to claim 10, further comprising generating instructions for controlling the decoder to retrieve the stored decoded information from a particular field when the protocol specification includes a reference to that particular field.

15. A method according to claim 10, wherein the disposition constraints comprise absolute and/or relative constraints including one or more of the following:
a starting bit of the field in the data packet;
a finishing bit of the field in the data packet;
an offset from a known position in the data packet;
a length of the field;
a known type of field

16. A method of decoding data packets from a telecommunications network, each of the data packets having a plurality of fields formatted in a predetermined protocol defined by a protocol specification, comprising:
receiving, directly or indirectly, the decoding instructions generated by:
receiving the protocol specification;
analyzing the protocol specification to infer disposition constraints for each field formatted in the corresponding protocol;
determining an appropriate representation of that particular field based on the inferred disposition constraints so as to optimize operation of the decoder; and
generating instructions for controlling the decoder to decode the data packets from the telecommunications network and to store decoded information from a particular field according to the appropriate representation to optimize reuse of that decoded information;
receiving data packets from the telecommunications network;
decoding the data packets according to the received decoding instructions;
storing appropriate decoded information from a particular field according to the decoding instructions; and
providing data from the decoded data packets.

17. A method according to claim 16, further comprising compiling the received decoding instructions into a format suitable for use by a decoder.

18-21. (canceled)
